(19) United States
(12) Patent Application Publication
(10) Pub. No.: US 2020/0196568 A1
(43) Pub. Date: Jun. 25, 2020

(54) SYSTEM AND METHOD FOR CONTROLLING ANIMAL FEED

(71) Applicant: Neuromation, Inc., San Francisco, CA (US)

(72) Inventors: Timothy L. ROBERTSON, Belmont, CA (US); Yashar BEHZADI, Orinda, CA (US); Ricardo Alexandre ESTEVES MENDONCA, San Jose, CA (US)

(73) Assignee: Neuromation, Inc., San Francisco, CA (US)

(21) Appl. No.: 16/231,283

(22) Filed: Dec. 21, 2018

(51) Int. Cl. A01K 5/02; A01K 61/85; A01K 29/00

(52) U.S. Cl. CPC A01K 5/0283; A01K 5/0291; A01K 39/014; A01K 29/005; A01K 61/85

(57) ABSTRACT

A system and method are disclosed for adjusting a future feeding cycles based on analysis of feed consumption during and at the end of a current feed cycle. The system and method are applicable to any environment where animals are fed, including containers that hold feed and containers that hold the animal and the feed, such as a fish tank.

### FIELD OF THE INVENTION

The invention is in the field of computer systems and, more specifically, related to systems for feed control using artificial intelligence detection techniques.

### BACKGROUND

Most feed adjustment, as currently done, is performed by a user. There is little accuracy and poor overall consistency. Furthermore, it is very time consuming for a user, especially on a large farm, to go from feeding location to feeding location. Therefore, what is needed is a system and method that allows accurate estimation of feed consumption to adjust future feed delivery.

### SUMMARY OF THE INVENTION

The invention discloses a system and method for accurate estimation of feed consumption to adjust future feed delivery. Systems that embody the invention, in accordance with the aspects and embodiments of the invention, include a feed control system for generating an indicator used to adjust future feeding. The feed control system includes a processing system, a database in communication with the processing system, a device for collecting information related to feed quantity level in the container, and a unit for detecting the presence of animals.

### BRIEF DESCRIPTION OF THE DRAWINGS

FIG. 1A shows a system for adjusting future feed delivery in accordance with the various aspects and embodiments of the invention.

FIG. 1B shows a system for adjusting future feed delivery in accordance with the various aspects and embodiments of the invention.

FIG. 2 shows a flow process for adjusting future feed delivery in accordance with the various aspects and embodiments of the invention.

FIG. 3 shows a flow process for adjusting future feed delivery using user feedback in accordance with the various aspects and embodiments of the invention.

FIG. 4 shows a process for future feed delivery adjustment using Artificial Intelligence feedback in accordance with the various aspects and embodiments of the invention.

FIG. 5A shows a system in communication with a network in accordance with an embodiment of the invention.

FIG. 5B shows a system in accordance with an embodiment of the invention.

FIG. 6 shows a system in accordance with an embodiment of the invention.

FIG. 7 shows an example of a computer readable media in accordance with an embodiment of the invention.

FIG. 8 shows an example of a computer readable media in accordance with an embodiment of the invention.

FIG. 9 shows a server in accordance with an embodiment of the invention.

FIG. 10 shows a block diagram of a server in accordance with an embodiment of the invention.

### DETAILED DESCRIPTION

To the extent that the terms “including”, “includes”, “having”, “has”, “with”, or variants thereof are used in either the detailed description and the claims, such terms are intended to be inclusive in a similar manner to the term “comprising”. The invention is described in accordance with the aspects and embodiments in the following description with reference to the FIGs., in which like numbers represent the same or similar elements.

Reference throughout this specification to “one embodiment,” “an embodiment,” or “in accordance with some aspects” and similar language means that a particular feature, structure, or characteristic described in connection with the various aspects and embodiments are included in at least one embodiment of the invention. Thus, appearances of the phrases “in accordance with an aspect,” “in accordance with one embodiment,” “in an embodiment,” “in certain embodiments,” and similar language throughout this specification refer to the various aspects and embodiments of the invention. It is noted that, as used in this description, the singular forms “a,” “an” and “the” include plural referents, unless the context clearly dictates otherwise.

The described features, structures, or characteristics of the invention may be combined in any suitable manner in accordance with the aspects and one or more embodiments of the invention. In the following description, numerous specific details are recited to provide an understanding of various embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring the aspects of the invention.

The ranges of values provided above do not limit the scope of the present invention. It is understood that each intervening value, between the upper and lower limit of that range and any other stated or intervening value in that stated range, is encompassed within the scope of the invention. The upper and lower limits of these smaller ranges may independently be included in the smaller ranges and are also encompassed within the invention, subject to any specifically excluded limit in the stated range. Where the stated range includes one or both of the limits, ranges excluding either or both of those included limits are also included in the invention.

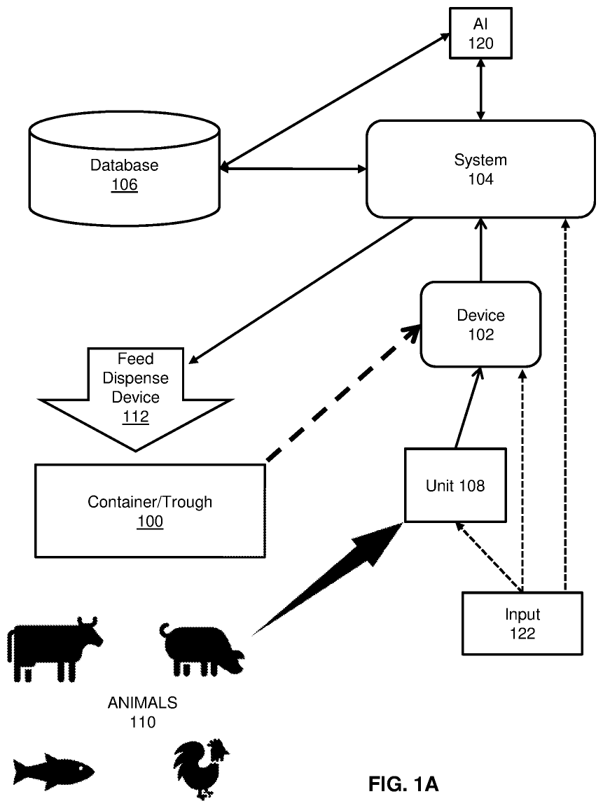

Referring now to FIG. 1A and FIG. 1B, a container or trough 100 is shown in accordance with one embodiment. In accordance with one embodiment, the container is a tank that includes fish and the food source is introduced in the container, wherein the fish are swimming. Thus, in accordance with the embodiment, the environment that animals, such as fish, are living in may be encompassed by or the same as the container, wherein the food is introduced; accordingly, the discussions that follow are also applicable to any embodiment regardless of the type or purpose of the container.

A device 102 is positioned near the container 100 to collect information about the feed levels in the container 100. In accordance with one embodiment of the invention, the device 102 capture images of the container 100 and the images are analyzed, as outline below, to determine feed levels. In accordance with one embodiment of the invention, the device 102 is a scale that measures the weight of the container 100 to determine feed level in the container. In accordance with one embodiment of the invention, the device 102 uses a light beam or light source with a sensor to detect the level of feed in the container 100. For example, as the level of feed increases, light beams set at different heights are blocked and as the level of feed drops, light beams are detected by their respective sensor. In accordance with an embodiment of the invention, the device 102 detects sounds or vibration at the container 100. For example, as the feed level in the container 100 changes, so does the sound (and the sonic characteristics) generated at the container 100.

In accordance with an embodiment, wherein the container 100 is a tank that includes fish, in accordance with one aspect of the invention, a section or portion of the container is dedicated for introducing and receiving the feed and activity of the animals are monitored near the feeding area of the container. The food level is monitored in this area of the container.

In accordance with an embodiment of the invention, the device 102 is a camera that captures still images or photos over a period of time. In accordance with an embodiment of the invention, the device 102 is a video camera that captures continuous video or segments of video over a period of time. In accordance with one embodiment of the invention, the device 102 continuously records the activity at the container 100. In accordance with another embodiment of the invention the device 102 captures instantaneous images over a period of time. The device 102 is in communication with a processing system 104, such as a server or a computer that includes a processor, and a database 106. In accordance with an embodiment of the invention, the system 104 is remote from the database 106, as shown in FIG. 1A. In accordance with an embodiment of the system 104 includes the database 106, as shown in FIG. 1B. In accordance with an embodiment of the invention, the system 104 communicates with a remotely located artificial intelligence (AI) module 120, as shown in FIG. 1A. In accordance with an embodiment of the invention, the system 104 includes the artificial intelligence (AI) module 120, as shown in FIG. 1B.

Referring again to FIG. 1 A and FIG. 1 B, the device 102 monitors the container 100 to collect feed information. A unit 108 is in communication with the device 102. In accordance with an embodiment of the invention, the unit 108 is a motion sensor. In accordance with an embodiment of the invention, the unit 108 detects a signal transmitted by a wearable tag associated with animals that are in proximity of the unit 108. In accordance with an aspect of the invention, the unit 108 includes an animal-based sensor that receives animal physiological information from a physiological measuring unit on the animal.

In accordance with an embodiment of the invention, the unit 108 is an RFID sensor. In accordance with an embodiment of the invention, the unit 108 includes a weight detector that detects a change in weight near the container 100 when animal 110 stand near the container. In accordance with an embodiment of the invention, the unit 108 includes an acoustic sensor that detects sound indicative of the presence of animals 110.

In accordance with some embodiments of the invention, the device 102, the system 104, and the unit 108 are in communication with an input means 122, such as a control panel, keyboard, touch-screen or a portable wireless communication input station, such as a tablet or a Personal Digital Assistant (PDA). Using the input means 122, other systems, such as a weather station or a user, can input/provide information about weather conditions and the animals' characteristics to the system 104. The animal characteristic or behavior can be provided as group level information or as individual animal information. In accordance with an embodiment of the invention, weather information and the animal's behavior or characteristics can be inputted directly into the system 104 or provided to the device 102 and passed to the system 104 or provided to the unit 108 and passed on to the system 104 through the device 102.

When the unit 108 is triggered by the presence of animals 110, the unit 108 sends a signal to the device 102 to start collecting information, for example to start recording or capturing images. Once the device 102 is activated to collect information. The device 102 sends the collected information, such as the video or images, to the system 104. In accordance with one embodiment of the invention, the information from the device 102 is transmitted to the system 104 using over a wireless communication link that uses any known wireless protocol. In accordance with one embodiment of the invention, the information from the device 102 is sent to the system 104 using any known wired or physical communication link.

The system 104 receives and processes the information from the device 102. In accordance with an aspect if the invention, the information is video or still images. The system 104 compares the information received from the device 102 with information stored in the database 106. For example, the system 104 compares the information, such as images or video, with the sample information stored in the database 106. When the system 104 detects a match between the image from the device 102 and the sample images stored in the database 106, the system 104 generates feed adjustment information.

In accordance with an embodiment of the invention, the feed adjustment information is sent to a user operating a feed dispensing device 112. The user adjusts the feed based on the feed adjustment information. For example, the feed adjustment information can be used to adjust the feed quantity, the feed mix, the feed timing, the location of the feed in the container 100 when delivering feed on the next feeding cycle or any parameter associated with deliver of the feed. As referred to herein, a feeding cycle starts when the feed is delivered to the container through the time when the animals 110 are finished eating.

In accordance with an embodiment of the invention, the feed adjustment information is sent directly to the feed dispensing device 112. The feed dispensing device 112 adjusts the feed for the next feed delivery. As noted, the feed dispensing feed adjustment information can be used to adjust the feed quantity, the feed mix, the feed timing, the location of the feed in the container 100 when delivering feed on the next feeding cycle or any parameter associated with deliver of the feed.

In accordance with an embodiment of the invention, the system 104 includes the device 102, the database 106, the device 108, the AI unit 120, and the input means 122.

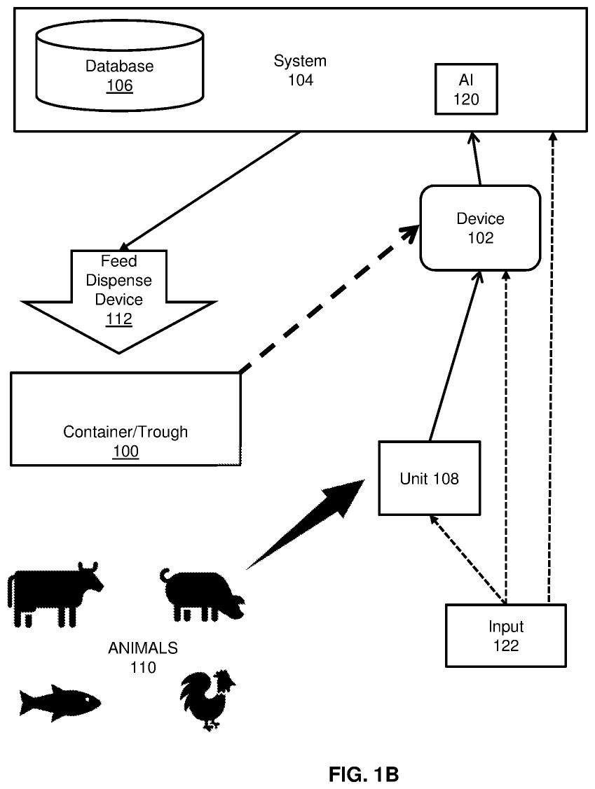

Referring now to FIG. 2, a process 200 is shown for adjusting future feed delivery in accordance with the various aspects and embodiments of the invention. Upon activation of the device 102, at step 202, information related to the feed level is collected. At step 204, the collected information is sent to the system 104 for analysis. At step 206, the system 104 analyzes the collected information to determine feed level related to the current feeding cycle. As noted above, in accordance with some embodiments of the invention, the collected information may be continuous video recording or instantaneous images captured at various times or just one image captured at the end of the current feeding cycle.

For example, in accordance with one embodiment, the collected information, which the system 104 receives from the device 102, is an image at the end of the current feeding cycle or multiple images throughout the current feeding cycle. The system 104 retrieves sample images from the database 106. According to one aspect of the invention, the sample images stored in the database 106 are categorized or tagged with labels that identify the feed level. Examples of tags for feed level include a numerical ranking between 0 and 4, wherein a high number indicates a fuller container. Thus, “4” represents a full container and “0” represents an empty container.

In accordance with one aspect of the invention, the sample images are actual image that have been previously captured, categorized or tagged, and stored in the database 106. In accordance with one aspect of the invention, the sample images are synthetic image that are generated using virtual reality modeling. The virtual reality generated images are categorized or tagged, which can be done using artificial intelligence or through user input/feedback. Further, the virtual reality images can be used to train an artificial intelligence system. Regardless of the data being actual images or synthetic images, the data is used for validation, training, and updating the system.

In accordance with one aspect of the invention, the device 102 divides the container 100 into sections and the indicator generated by the system 104 includes multiple section indicators representing the feed quantity levels in multiple sections of the container 100, such that there is one section indicator for each section of the container 100.

In accordance some aspects of the invention, comparison of images includes correlation between two near like image that have the same tag or category. The comparison may also result in a near match between the collected image from the device 102 and two images from the database 106, each of which fall into a different category or are tagged with a different label. The AI unit 120 selects one of the two images from the database. The selected image along with collected image, from the device 102, are send to the user for feedback. The AI unit 120 can use the feedback to train the analysis model used by the AI unit 120 and the system 104. Additionally, the image provided by the device 102 can be tagged and classified using the feedback. The AI unit 120 can use real or synthetic image, which are virtually generated.

Referring again to FIG. 2, at step 206 the system 104 analyzes the information. As noted above, the analysis can be performed by the system 104 that includes the AI module 120 or the system 104 communicates with a remotely located AI module 120 that performs the analysis and provides the outcome of the analysis to the system 104. Additionally, as noted herein, in accordance with some aspects of the invention, the analysis may include factoring in information about environmental conditions, such as weather conditions, and/or behavioral information, such as animal characteristics.

In accordance with an embodiment of the invention, the analysis tool is part of and running in the system 104. In an embodiment, wherein the system 104 includes the AI unit 120, reference is made to the system 104 performing the analysis. Accordingly, the system 104 compares images received from the device 102 to various sample images stored in the database 106. The system 104 determines if there is a match between the image received from the device 102 and any sample image. If a match if found, then at step 208 the system 104 provides an indicator that is used to adjust future feed delivery for future feeding cycles.

In accordance with various aspects of the invention, the indicator generated by the system 104 may include information about timing and duration of a feeding cycle. Furthermore, the indicator may include information about the duration of time an animal spends at the container 100, using a tracking device that is used to tag the animal. The AI unit 120 receive images captured at the device 102. The AI unit 120 builds a database of the animal and can perform facial-recognition to identify each animal in the image to determine how long each animal spends at the container 100. In accordance with an embodiment of the invention, the unit 108 includes a sensor that measures distance of any animal from the container 100 by detecting an individual animal's tag information, such an ear tag that includes RFID tags with proximity detection by the unit 108 or branding or color characteristics of the animal to identify the animal using visual analysis by the AI unit 120.

In accordance with an embodiment of the invention, the AI unit 120 is remotely located and the system 104 communicates with the AI unit 120. The system 104 sends the image from the device 102 to the AI unit 120. The AI unit 120 accesses the database 106 to retrieve sample images. The AI unit 120 compares the image with the sample images and provides an indicator or a response that is sent to the system 104.

Referring again to FIG. 2, at step 206, the analysis performed by the analysis tool, as outlined herein and discussed herein, may be performed in any manner. For example and as noted, the analysis is performed using the AI unit 120. The AI unit 120 compares images from the device 102 with sample images. Once the AI unit 120 performs the analysis and identifies a sample image that most closely correlates to the image provided by the device 102, the resulting match is used to provide analysis information or an indicator. At step 208, the system 104 provides an indicator to the user of the feed dispensing device 112 or the feed dispensing device 112 directly. At step 210, the analysis information or indicator is used to adjust future feed delivery, as outlined herein. In accordance with an embodiment of the invention, information collected by the device 102 and send to the system 104 a tracking, for each animal, when the animal was feeding and in proximity to the container to estimate the feed quantity consumed by the animal.

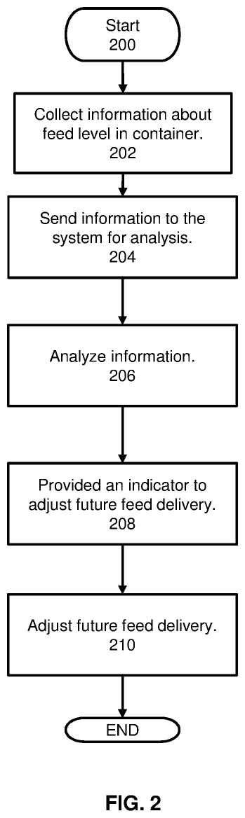

Referring now to FIG. 3 and in accordance with some aspects of the invention, the indicator or analysis information is provided to the user, the user can provide feedback. A process 300 is shown for adjusting future feed delivery and receiving feedback from a user to correct future feed delivery. Upon activation of the device 102, at step 302, information related to the feed level is collected. At step 304, the collected information is sent to the system 104 for analysis. At step 306, the system 104 analyzes the collected information to determine feed level related to the current feeding cycle. At step 308, the system 104 provides an indicator and the information, such as the images captured by the device 102, to the user. At step 312, the user can review the images captured by the device 102 and determine if the indicator is accurate. At step 314, the system 104 determines, based on user feedback, if the indicator is accurate. If the indicator is accurate, the process continues to step 310 to adjust future feed delivery. If the indicator is not accurate, the user provides feedback to the system 104, the system 104 updates the indicator for adjusting future feed delivery, and the system 104 uses the feedback to improve and train the AI unit 120. In accordance with some aspects of the invention, if the indicator is not accurate, based on the user's feedback, then the system 104 uses the feedback to update or improve the stored images in the database 106.

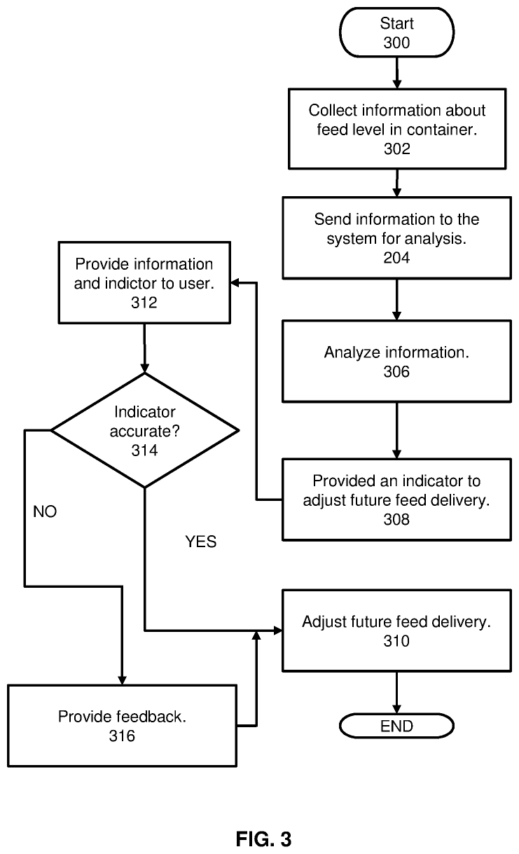

Referring now to FIG. 4 and in accordance with some aspects of the invention, the indicator or analysis information is provided to the AI unit 120 and the AI unit 120. A process 400 is shown for adjusting future feed delivery and receiving feedback to correct future feed delivery. At step 402, information related to the feed level is collected. At step 404, the collected information is sent to the system 104 for analysis. At step 406, the system 104 analyzes the collected information to determine feed level related to the current feeding cycle. At step 408, the system 104 generates an indicator based on the images captured by the device 102. At step 412, the system 104 send the indicator and the images captured by the device 102 to the AI unit 120; the AI unit 120 determines if the indicator is accurate. If the indicator is accurate, the process continues to step 410 and adjustments are made, as needed, to future feed delivery. If the indicator is not accurate, then the AI unit 120 provides feedback at step 414. The feedback can be in any form, such as updating tag inform associated with the images captures by the device 102, updating the database 106 and/or training the system 104. At step 416, the AI unit 120, through the system 104, corrects the indicator and the process proceeds to step 410 to adjust future feed delivery.

In accordance with various aspects and embodiments of the invention, information collected about each animal can be used determine behavior of the animal. For example, eating patterns about the animals can be used to predict social and feeding behavior, which is based on historic information or data that was collected and analyzed. The social behavior would indicate aggression character and behavior in proximity to the feeding time. This allows analysis of potential social impact on the development and growth of the animal. Additionally, the analysis can be performed over multiple feedlots within the same location, thereby allowing data to be collected for an entire farm with multiple feedlots. This information can be used to detect any anomaly in the feeding cycle or feeding pattern for: an animal, a group of animals, or multiple groups of animals in a farm.

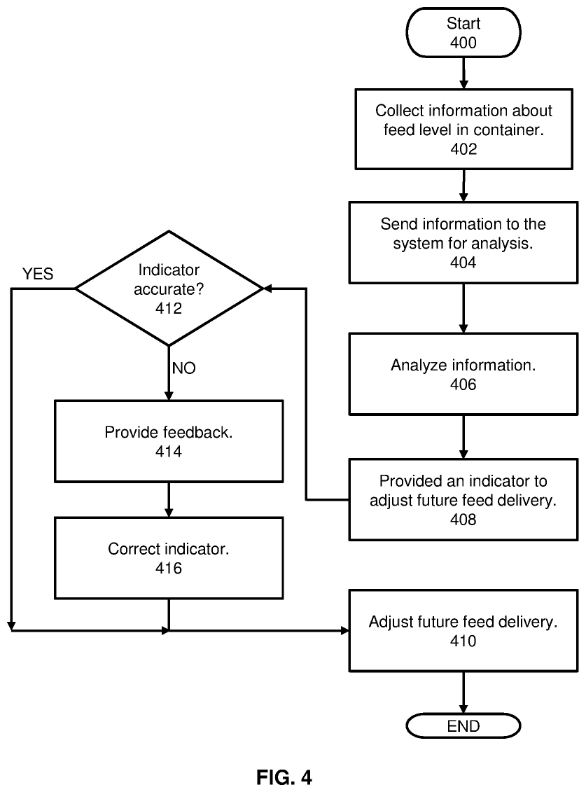

Referring now to FIG. 5A, a network 502 is shown in accordance with an embodiment and various aspects of the invention. The system 104 is in communication with the network 502. The network 502 allows communication between the various units or devices that are controlled by or in communication with the system 104.

Referring now to FIG. 5B, a system 500 is shown in accordance with an embodiment and various aspects of the invention. The system 500 includes the network 502. In accordance with one embodiment of the invention, the network 502 is part of the system 104.

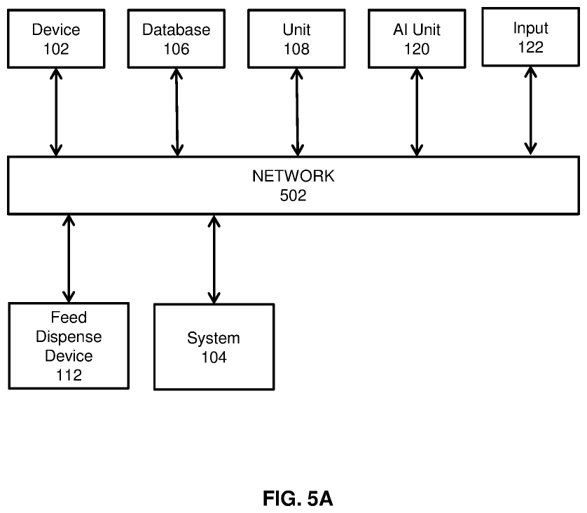

Referring now to FIG. 6, a system 600 is shown in accordance with an embodiment and various aspects of the invention. The system 600 includes the network 502, the device 102, the database 106, the unit 108, the AI unit 120, and the input means 122. The system 600 communicates with the feed dispensing device 112 using the network 502. As noted, the system 600 can also send or provide information to the user. Further, the system 600 also communicates with external systems 610, such as system that provide environmental information.

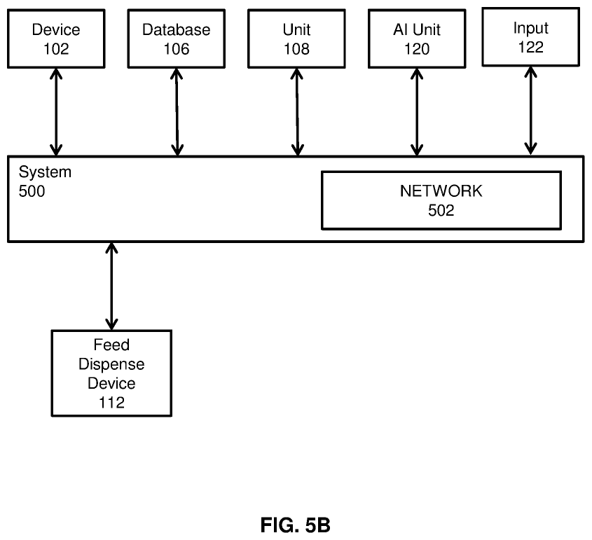

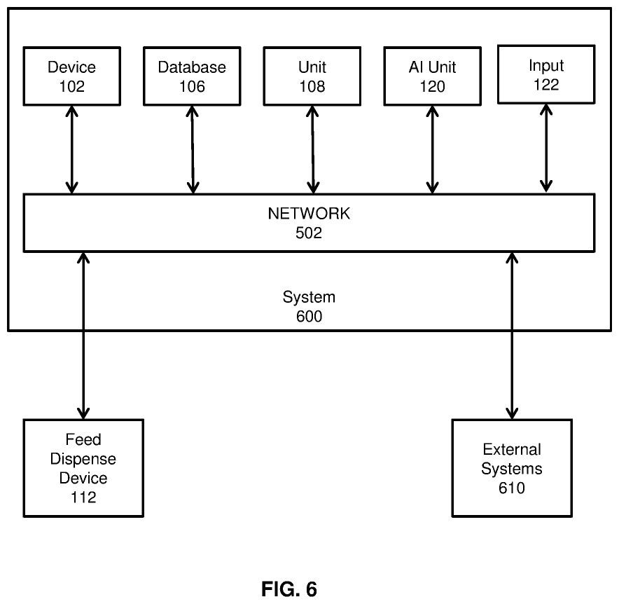

The systems discussed herein work by executing software on computer processors. A computer or computing device or computer processor includes a non-transitory computer readable medium or storage that may include a series of instructions, such as computer readable program steps or code encoded therein. In certain aspects of the invention, the non-transitory computer readable medium includes one or more data repositories. Thus, in certain embodiments that are in accordance with any aspect of the invention, computer readable program code (or code) is encoded in a non-transitory computer readable medium of the computing device. The processor or a module, in turn, executes the computer readable program code to create or amend an existing computer-aided design using a tool. The term “module” as used herein may refer to one or more circuits, components, registers, processors, software subroutines, or any combination thereof. In other aspects of the embodiments, the creation or amendment of the computer-aided design is implemented as a web-based software application in which portions of the data related to the computer-aided design or the tool or the computer readable program code are received or transmitted to a computing device of a host. Various embodiments store software for such processors as compiled machine code or interpreted code on non-transitory computer readable media. FIG. 7 and FIG. 8 show examples of non-transitory computer readable media. FIG. 7 shows a magnetic disk memory device 710. FIG. 8 shows a solid-state memory device 810, such as a RAM or DRAM.

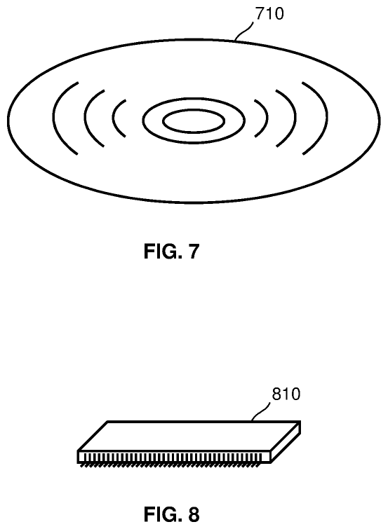

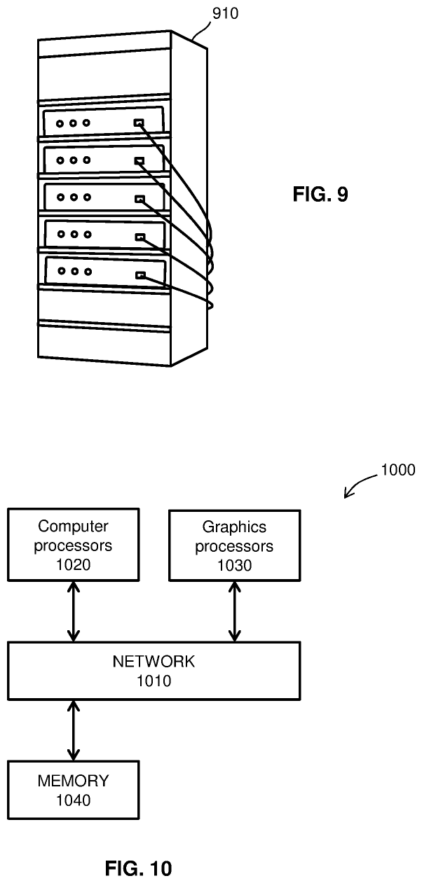

FIG. 9 shows a server 910. The system 104 or other devices or units disclosed herein communicate, through the wireless or wired connections and the internet, to the server 910. The server 910 is capable of further performs methods described herein. The server uses high-performs multi-core processors to execute code. Referring now to FIG. 10, a block diagram is shown of a server 1000 that includes a network 1010, multi-core processors 1020, graphics processors 1030, and memory 1040. The network 1010 includes a network interface for communication, using wired and wireless protocols.

Accordingly, the preceding merely illustrates the various aspects and principles as incorporated in various embodiments of the invention. It will be appreciated that those of ordinary skill in the art will be able to devise various arrangements which, although not explicitly described or shown herein, embody the principles of the invention and are included within its spirit and scope. Furthermore, all examples and conditional language recited herein are principally intended to aid the reader in understanding the principles of the invention and the concepts contributed by the inventors to furthering the art, and are to be construed as being without limitation to such specifically recited examples and conditions. Moreover, all statements herein reciting principles, aspects, and embodiments of the invention, as well as specific examples thereof, are intended to encompass both structural and functional equivalents thereof. Additionally, it is intended that such equivalents include both currently known equivalents and equivalents developed in the future, i.e., any elements developed that perform the same function, regardless of structure.

In accordance with the teaching of the invention a computer and a computing device are articles of manufacture. Other examples of an article of manufacture include: an electronic component residing on a mother board, a server, a mainframe computer, or other special purpose computer each having one or more processors (e.g., a Central Processing Unit, a Graphical Processing Unit, or a microprocessor) that is configured to execute a computer readable program code (e.g., an algorithm, hardware, firmware, and/or software) to receive data, transmit data, store data, or perform methods.

Additionally, it is intended that such equivalents include both currently known equivalents and equivalents developed in the future, i.e., any elements developed that perform the same function, regardless of structure. The scope of the invention, therefore, is not intended to be limited to the exemplary embodiments shown and described herein.

Unless defined otherwise, all technical and scientific terms used herein have the same meaning as commonly understood by one of ordinary skill in the art to which this invention belongs. The verb couple, its gerundial forms, and other variants, should be understood to refer to either direct connections or operative manners of interaction between elements of the invention through one or more intermediating elements, whether or not any such intermediating element is recited. Any methods and materials similar or equivalent to those described herein can also be used in the practice of the invention. Representative illustrative methods and materials are also described.

An article of manufacture or system, in accordance with various aspects of the invention, is implemented in a variety of ways: with one or more distinct processors or microprocessors, volatile and/or non-volatile memory and peripherals or peripheral controllers; with an integrated microcontroller, which has a processor, local volatile and non-volatile memory, peripherals and input/output pins; discrete logic which implements a fixed version of the article of manufacture or system; and programmable logic which implements a version of the article of manufacture or system which can be reprogrammed either through a local or remote interface. Such logic could implement a control system either in logic or via a set of commands executed by a processor.

All publications and patents cited in this specification are herein incorporated by reference as if each individual publication or patent were specifically and individually indicated to be incorporated by reference and are incorporated herein by reference to disclose and describe the methods and/or system in connection with which the publications are cited. The citation of any publication is for its disclosure prior to the filing date and should not be construed as an admission that the invention is not entitled to antedate such publication by virtue of prior invention. Further, the dates of publication provided may be different from the actual publication dates which may need to be independently confirmed.

Therefore, the scope of the invention is not intended to be limited to the various aspects and embodiments discussed and described herein. Rather, the scope and spirit of invention is embodied by the appended claims.

What is claimed is:

1. A feed control system for generating an indicator used to adjust future feeding introduced to a container, the feed control system comprises:
a processing system;
a database in communication with the processing system;
a device for collecting information related to feed quantity level in the container, the device is in communication with the processing system; and
a unit for detecting the presence of animals, the unit is in communication with the device;
wherein the unit signals the device when animals are present at the container;
wherein the device collects information about the feed quantity level as animals access the container and consume the feed,
wherein the system processor receives the collected information as input from the device,
wherein the system processor analyzes the collected information using a model and generates an indicator that is used to adjust future feeding cycles.

2. The feed control system of claim 1, wherein the unit is a motion sensor.

3. The feed control system of claim 1, wherein the device is a video camera and the collected information is a video.

4. The feed control system of claim 1, wherein the device is a camera and the collected information is at least one image.

5. The feed control system of claim 1, wherein the indicator is used to adjust future feed quantity.

6. The feed control system of claim 5, wherein the indicator is feed quantity remaining at the end of a feeding cycle.

7. The feed control system of claim 1, wherein the indicator is used to adjust at least one of a future feed composition and a future feed schedule.

8. The feed control system of claim 1, wherein the container is a tank for holding water and fish and the indicator is used to adjust future feed composition and feed schedule.

9. The feed control system of claim 1, wherein the indicator includes duration of the feeding cycle.

10. The feed control system of claim 1, wherein the indicator includes duration of time an animal spends feeding at the container.

11. The feed control system of claim 1, wherein an analysis model compares input from the device to a plurality of feed quantity level images to identify a match between the input from the device and at least one container food quantity level image selected from the plurality of container food quantity level images.

12. The feed control system of claim 1, wherein the unit is a motion sensor in communication with the device and wherein movement of any animal in proximity to the container is detected by the motion sensor, which provides a signal to activate the unit to collect information.

13. The feed control system of claim 1, wherein the unit 108 is a sensor, wherein the sensor detects and records a tracking signal for each animal and provides a tracking output for each animal to the processing system, thereby indicating that the animal was feeding and in proximity to the container to estimate the feed quantity consumed by the animal.

14. A non-transitory computer readable medium comprising code that, if executed by at least one computer processor comprised by a feed adjustment system, would cause the feed adjustment system to:
record feed level in a container as animals access the container and consume the feed;
generate an output signal that includes the recorded feed level;
analyze the output signal using a model to determine food consumption by the animals; and
provide a feed adjustment indicator that is used to change feed for a future feeding to optimize a future feed delivery.

15. The non-transitory computer readable medium of claim 14 includes code that when executed will allow the model to analyze the output signal based on at least one of forecast weather conditions, animal breed, animal age, animal size, target growth goal, feed composition, and market price for the animal.

16. A method for adjusting future food quantity levels for animals, the method comprising:
aiming a device at a trough;
recording feed quantity levels in the trough as animals access the trough and consume the feed;
receiving, from the device, information about the feed quantity levels;
analyzing the information to determine feed levels in the container at any given time during a feeding cycle; and
providing an indicator that is used to changes a future feeding to optimize the future feeding cycle.

17. The method of claim 16 further comprising providing an average rate of feed consumption for the feeding cycle.

18. The method of claim 16 further comprising providing a remaining feed quantity at the end of the feeding cycle.

19. The method of claim 16 further comprising providing information about the duration of time animals spend feeding at the trough.

20. The method of claim 16 further comprising:
dividing the trough into a plurality of sections; and
providing information about food quantity levels for each section of the plurality of sections.

21. The method of claim 16 further comprising:
comparing the input from the camera to a plurality of tagged images to identify a match between the input from the camera and at least one tagged image selected from the plurality of tagged images;
outputting, if there is a match, the input from the camera and the selected tagged image to a user;
receiving feedback from the user regarding accuracy of the match; and
updating, if the feedback shows a poor match, information associated with the tagged image.

22. The method of claim 21, wherein at least one tagged image of the plurality of tagged images is a synthetic image.

23. The method of claim 16 further comprising:
detecting movement of any animal in proximity to the trough; and
sending a signal to the camera in order to activate recording by the camera.

24. The method of claim 16 further comprising:
detecting movement of any animal in proximity to the trough;
sending a signal to the camera in order to capture information; and
transmitting the information to an analysis system.
